(19) United States
(12) Patent Application Publication
(10) Pub. No.: US 2026/0219209 A1
(43) Pub. Date: Jul. 30, 2026

(54) APPARATUS AND SYSTEM

(71) Applicant: CANON KABUSHIKI KAISHA, Tokyo (JP)

(72) Inventor: KOICHI OHTA, Kanagawa (JP)

(21) Appl. No.: 19/390,257

(22) Filed: Nov. 14, 2025

(30) Foreign Application Priority Data
Nov. 26, 2024 (JP) 2024-205453

(51) Int. Cl. G01N 23/04

(52) U.S. Cl. CPC G01N 23/04; G01N 2223/304; G01N 2223/413; G01N 2223/501; G01N 2223/504; G01N 2223/505

(57) ABSTRACT

An apparatus includes multiple pixels, a drive unit, and a reading unit. While radiation is emitted, a first operation is performed such that a driving signal is sequentially supplied and the reading unit generates a first signal, and a second operation is performed right after the first operation such that no driving signal is supplied and the reading unit generates a second signal. The first signal is corrected by using the second signal, and a data signal is generated.

### BACKGROUND

### Field of the Technology

The aspect of the embodiments relates to an apparatus and a system.

### Description of the Related Art

A radiation imaging apparatus is put into practical use as an imaging apparatus for use in medical image diagnosis or nondestructive inspection. In the case where a portion of the radiation imaging apparatus is intensely irradiated with radiation, a radiation image that is generated by the radiation imaging apparatus contains a crosstalk caused by signal leakage. In some cases, the radiation imaging apparatus performs a process of reducing the crosstalk. A technique described in Japanese Patent Laid-Open No. 2016-25465 is to reduce the crosstalk by repeating a conducting state and a non-conducting state regarding a sensor that detects radiation and subtracting a signal that is acquired in the non-conducting state from a signal that is acquired in the conducting state. A technique described in Japanese Patent Laid-Open No. 2009-74988 is to reduce an artifact that occurs due to the influence of leakage charge by correcting a signal while a detection element is switched on by using a signal while the detection element is switched off when a photographed image has a knockout.

The technique described in Japanese Patent Laid-Open No. 2016-25465 has room for improvement from the perspective of a frame rate and power consumption. The technique described in Japanese Patent Laid-Open No. 2009-74988 has difficulty in making a correction for radiographic imaging in which temporally continuous irradiation is performed. The disclosure is directed to provide a technique for reducing a crosstalk with precision in continuous radiographic imaging while a frame rate is inhibited from decreasing and power consumption is inhibited from increasing.

### SUMMARY

An apparatus includes: multiple pixels including respective conversion elements that convert radiation or light into an electric charge and respective switch elements that output the electric charge generated by the conversion elements or a signal based on the electric charge, the multiple pixels being arranged in a matrix; a drive unit that outputs a driving signal for driving the switch elements; multiple drive lines that supply the driving signal outputted by the drive unit to the switch elements; a reading unit that processes the signal outputted from the pixels, multiple signal lines that are provided in association with columns of the pixels and that supply the signal generated by the pixels to the reading unit; a control unit that controls an operation of the drive unit and an operation of the reading unit; and a generating unit that receives a signal outputted from the reading unit and that generates a data signal. While the radiation is emitted, the control unit causes a first operation to be performed such that the drive unit supplies the driving signal sequentially to the multiple drive lines, and the reading unit generates a first signal and causes a second operation to be performed right after the first operation such that the drive unit supplies no driving signal to the multiple drive lines, and the reading unit generates a second signal. The generating unit corrects the first signal by using the second signal and generates the data signal.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram for describing an example of the structure of a radiation imaging system according to an embodiment.

FIG. 2 is an equivalent circuit diagram for describing an example of the structure of a radiation detection panel according to an embodiment.

FIG. 3 schematically illustrates an example of the structure of a pixel according to an embodiment.

FIG. 4 illustrates an example of the operation of the radiation imaging system according to an embodiment.

FIG. 5 illustrates a mechanism of the occurrence of a crosstalk according to an embodiment.

FIG. 6A to FIG. 6D illustrate images in which the crosstalk occurs according to an embodiment.

FIG. 7 illustrates the flow of photographing according to an embodiment.

FIG. 8 schematically illustrates an example of the structure of a pixel according to an embodiment.

FIG. 9A to FIG. 9C illustrate images in which the crosstalk occurs according to an embodiment.

### DESCRIPTION OF THE EMBODIMENTS

### First Embodiment

Embodiments will hereinafter be described in detail with reference to the attached drawings. The embodiments below do not limit the disclosure. The embodiments have multiple features described below, but the multiple features are not necessarily essential for the disclosure, and the multiple features may be freely combined. In the attached drawings, components like or similar to each other are designated by using like reference characters, and a duplicated description is omitted.

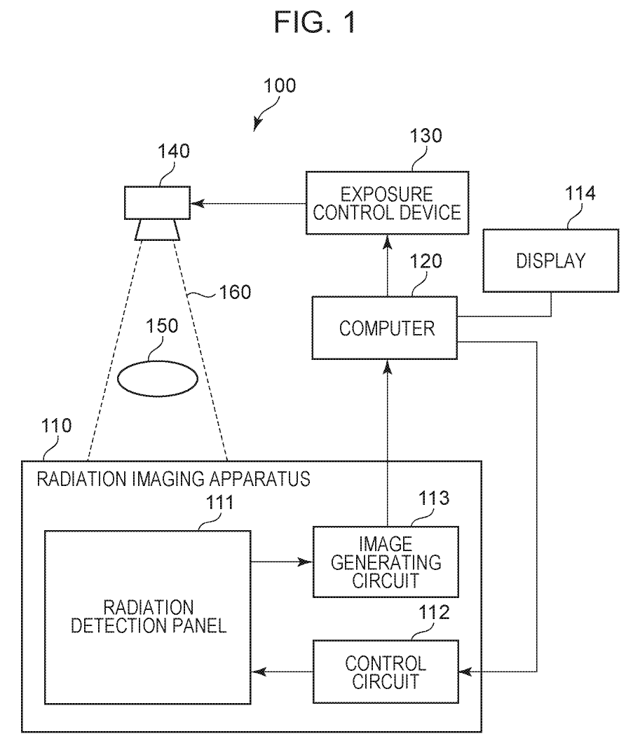

FIG. 1 illustrates an example of the structure of a radiation imaging system 100 according to an embodiment. The radiation imaging system 100 is configured to generate an electric radiation image by electrically imaging an optical image that is formed by radiation. The radiation is typically an X-ray but may be an α-ray, a β-ray, or a γ-ray. For example, the radiation imaging system 100 includes a radiation imaging apparatus 110, a computer 120 that is a control device, a display 114, an exposure control device 130, and a radiation generating device 140.

The radiation generating device 140 starts emitting radiation 160 in accordance with an exposure instruction (a radiation instruction) from the exposure control device 130. The radiation 160 that is emitted from the radiation generating device 140 enters the radiation imaging apparatus 110 via an object 150. The radiation generating device 140 stops emitting the radiation 160 in accordance with a stop instruction from the exposure control device 130.

The radiation imaging apparatus 110 includes a radiation detection panel 111, a control circuit 112, and an image generating circuit 113 that is an image generating unit. The image generating circuit 113 that is an image generating unit acquires a signal corresponding to image data from a reading circuit described later, makes a correction described later, and generates a radiation image data signal. The radiation imaging apparatus 110 generates a radiation image depending on the radiation 160 that enters the radiation imaging apparatus 110 and transmits the radiation image to the computer 120. The control circuit 112 controls the operation of the radiation detection panel 111.

For example, the control circuit 112 may include a PLD such as a FPGA or a dedicated circuit such as an ASIC. The FPGA is an abbreviation for Field Programmable Gate Array, the PLD is an abbreviation for Programmable Logic Device, and the ASIC is an abbreviation for Application Specific Integrated Circuit. Alternatively, the control circuit 112 may include a combination of a general-purpose processing circuit such as a processor and a storage circuit such as a memory. In this case, the general-purpose processing circuit may run a program that is stored in the storage circuit, and consequently, the function of the control circuit 112 may be fulfilled.

The image generating circuit 113 stores a signal that is supplied from the radiation detection panel 111 in the memory and generates the radiation image based on the signal. A method of generating the radiation image will be described in detail later. The image generating circuit 113 transmits the generated radiation image to the computer 120.

The computer 120 includes a control unit that controls the radiation imaging apparatus 110 and the exposure control device 130, a reception unit that receives the radiation image from the radiation imaging apparatus 110, and a signal processing unit that processes the radiation image acquired by the radiation imaging apparatus 110. The control unit, the reception unit, and the signal processing unit may include a dedicated circuit or may include a combination of a general-purpose processing circuit and a storage circuit as in the control circuit 112. In an example, the exposure control device 130 includes an exposure switch, and when the exposure switch is turned on by a user, the exposure control device 130 transmits an exposure instruction to the radiation generating device 140 and transmits a start notification that represents the start of emitting the radiation to the computer 120. The computer 120 that receives the start notification reports the start of emitting the radiation to the control circuit 112 of the radiation imaging apparatus 110 in response to the start notification. In the case where the exposure control device 130 and the computer 120 are not synchronously connected, the radiation detection panel 111 may detect the start of emitting the radiation 160, based on a pixel signal.

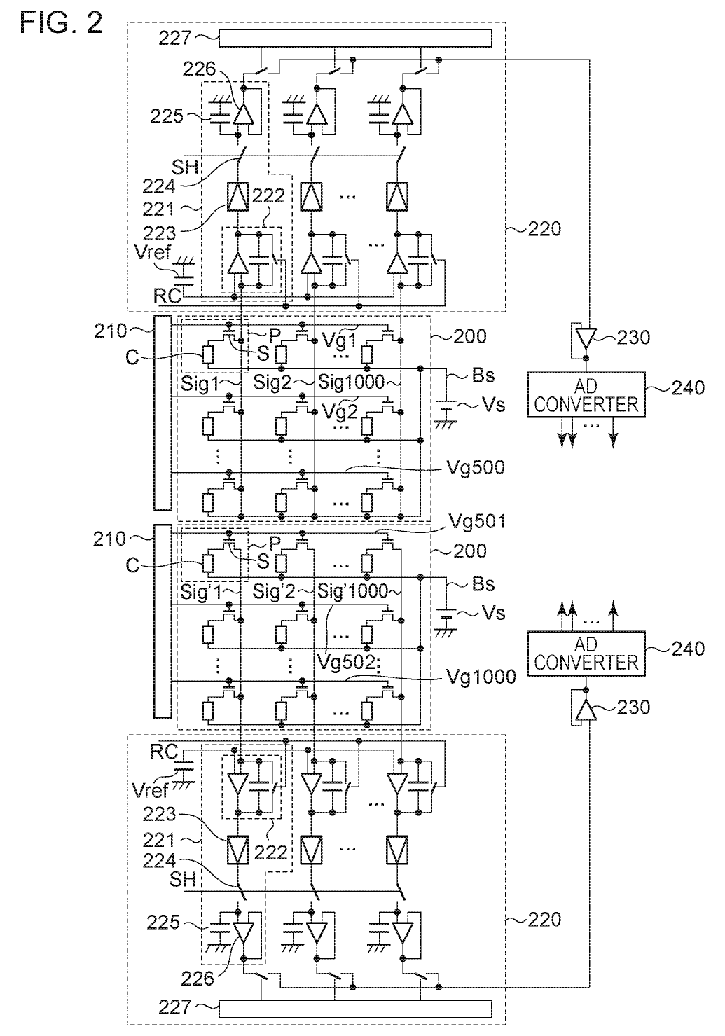

FIG. 2 illustrates an example of the structure of the radiation detection panel 111. For example, the radiation detection panel 111 includes pixel arrays 200, drive circuits 210 that are drive units, and reading circuits 220 that are reading units, buffer circuits 230, and analog-digital (AD) converters 240. The radiation detection panel 111 is divided in an up-down direction, and the pixel arrays 200, the drive circuits 210, the reading circuits 220, the buffer circuits 230, and the analog-digital (AD) converters 240 are symmetrical in the up-down direction. The drive circuits 210 and the reading circuits 220 function as peripheral circuits of the pixel arrays 200. For example, the pixel arrays 200 include multiple pixels P, multiple drive lines Vg1 to Vgm, multiple signal lines Sig1 to Sign at upper positions, multiple signal lines Sig'1 to Sig'n at lower positions, and bias lines Bs. The drive lines Vg1 to Vgm and the signal lines Sig1 to Sign and Sig'1 to Sig'n are collectively referred to as the drive lines Vg and the signal lines Sig. As illustrated in FIG. 2, the signal lines Sig are divided in the up-down direction. The multiple pixels P are arranged in a matrix so as to form multiple pixel rows and multiple pixel columns. Each pixel row corresponds to a group of multiple pixels that are arranged in a transverse direction in FIG. 2. Each pixel column corresponds to a group of multiple pixels that are arranged in a longitudinal direction in FIG. 2. As illustrated in FIG. 2, the pixel columns are divided in the up-down direction. In an example, the radiation detection panel 111 has a dimension of 9 inches, the pixel arrays 200 have 1000 pixel columns and 500 upper pixel rows and 500 lower pixel rows, that is, 1000 rows in total.

The pixel rows of the pixel arrays 200 are referred to as the first row to the m-th row (m is an integer of no less than 1 and no more than 1000) in top-down order. The pixel columns of the pixel arrays 200 are referred to as the first column to the n-th column (n is an integer of no less than 1 and no more than 1000) in left-right order in FIG. 2. Each pixel P includes a combination of a conversion element C and a switch element S. The pixel P that is located in the i-th row and the j-th column in the pixel arrays 200 is referred to as the pixel P (i, j). The conversion element C and the switch element S that are included in the pixel P (i, j) are referred to as the conversion element C (i, j) and the switch element S (i, j). For example, the pixel P (1, 2) represents the pixel P in the first row and the second column.

Each conversion element C generates an electric charge depending on the radiation that enters the pixel P and accumulates the electric charge.

Each conversion element C can accumulate an electric charge that occurs due to dark current in addition to the electric charge depending to the radiation. The generation and accumulation of the electric charge by using the conversion element C of each pixel P are referred to as the generation and accumulation of the electric charge by using the pixel P.

Each switch element S is connected between the conversion element C and the signal line Sig corresponding to the conversion element C. For example, the switch elements S (1, 1) to S (m, 1) are connected between the multiple conversion elements C (1, 1) to C (m, 1) and the signal line Sig1. When each switch element S is turned on, the conversion element C and the signal line Sig are brought into a conducting state, the electric charge (such as the electric charge accumulated by the conversion element C) that is acquired by the conversion element C is transferred to the signal line Sig. An example of each conversion element C may be a MIS photodiode that is disposed on an insulating substrate such as a glass substrate and that is mainly composed of amorphous silicon. Alternatively, each conversion element C may be a PIN photodiode. Each conversion element C may be a direct conversion element that directly converts the radiation into the electric charge or may be an indirect conversion element that converts the radiation into light and that subsequently detects the light. As for the indirect conversion element, a scintillator may be shared by multiple pixels P.

For example, each switch element S includes a transistor such as a thin film transistor (TFT) that has a control terminal (a gate) and two main terminals (a source and a drain). Each conversion element C includes two main electrodes. One of the main electrodes of the conversion element C is connected to one of the two main terminals of the switch element S, and the other main electrode of the conversion element is connected to a bias power source Vs with the common bias line Bs interposed therebetween. The bias power source Vs generates a bias voltage.

The control terminal of the switch element S of each pixel P in the first row is connected to the drive line Vg1. The control terminal of the switch element S of each pixel P in the second row is connected to the drive line Vg2. The same is true for the third to m-th rows.

The drive circuits 210 supply a driving signal to the control terminals of the switch elements S of the pixels P via the drive lines Vg in accordance with a driving signal that is supplied from the control circuit 112. The driving signal includes an on signal (a high level of voltage in the description below) for turning on the switch elements S and an off signal (a low level of voltage in the description below) for turning off the switch elements S. In some cases, a state in which the off signal is supplied will be described as a state in which no driving signal is supplied for convenience of description below. In these cases, a state in which the on signal is supplied will be described as a state in which the driving signal is supplied. For example, each drive circuit 210 includes a shift register, and the shift register performs a shift operation in accordance with a control signal (for example, a clock signal) that is supplied from the control circuit 112.

The supply of an on signal (that is, a high level of driving signal) to a pixel P is referred to as the selection of the pixel P or the supply of the driving signal. That is, the driving signal is a signal for selecting any one of the multiple pixels P. The same driving signal is supplied to multiple pixels in the same pixel row. The selection of multiple pixels in a single pixel row is referred to as the selection of the pixel row.

Each reading circuit 220 reads and amplifies a signal that appears on the signal line Sig by selecting each pixel P. The signal corresponds to the electric charge that is accumulated by the conversion element C. Reading the signal corresponding to the electric charge that is accumulated by the conversion element C of the pixel P is referred to as reading the signal corresponding to the electric charge that is accumulated by the pixel P.

Each reading circuit 220 includes amplification circuits 221 for the respective signal lines Sig. In an example in FIG. 2, the pixel arrays 200 include n signal lines Sig at upper and lower positions, and accordingly, the reading circuits 220 include n amplification circuits 221 at upper and lower positions. For example, each amplification circuit 221 includes an integrator amplifier 222, a variable amplifier 223, a switch element 224, a capacitance 225, and a buffer circuit 226. The switch element 224 and the capacitance 225 are included in a sample-and-hold circuit. For example, the integrator amplifier 222 includes an operational amplifier, and an integral capacitance and a reset switch that are connected in parallel between an inverting input terminal and an output terminal of the operational amplifier. A reference voltage is applied from a reference power supply Vref to a non-inverting input terminal of the operational amplifier. If the reset switch is turned on depending on a control signal RC (a reset pulse) that is supplied from the control circuit 112, the integral capacitance is reset, and the electric potential of each signal line Sig is reset to reference electric potential. The variable amplifier 223 amplifies a signal from the integrator amplifier 222 at a set amplification factor. The sample-and-hold circuit samples and holds a signal from the variable amplifier 223. Turning on and off the switch element 224 that is included in the sample-and-hold circuit is controlled by using a control signal SH that is supplied from the control circuit 112. The buffer circuit 226 buffers (impedance conversion) and outputs a signal from the sample-and-hold circuit. In some cases, pixels P that are connected to the reading circuit located at an upper position in FIG. 2 are referred to as some pixels in the description below.

In some cases, pixels P that are connected to the reading circuit located at a lower position are referred to as other pixels other than some pixels. In some cases, the reading circuit that is located at the upper position is referred to below as a first reading circuit (a first reading unit). In some cases, the reading circuit that is located at the lower position is referred to below as a second reading circuit (a second reading unit).

Each reading circuit 220 also includes a multiplexer 227 that selects and outputs signals from the multiple amplification circuits 221 in a predetermined order. For example, the multiplexer 227 includes a shift register, and the shift register performs a shift operation in accordance with a control signal (such as a clock signal) that is supplied from the control circuit 112. As a result of the shift operation, one of the signals from the multiple amplification circuits 221 is selected.

The buffer circuits 230 buffer (impedance conversion) signals that are outputted from the multiplexers 227. The AD converters 240 convert analog signals that are outputted from the buffer circuits 230 into digital signals. The output of each AD converter 240, that is, a pixel signal (in some cases, this will be described as an image data signal below) is processed by the image generating circuit 113 that is an image generating unit and is subsequently transmitted to the computer 120.

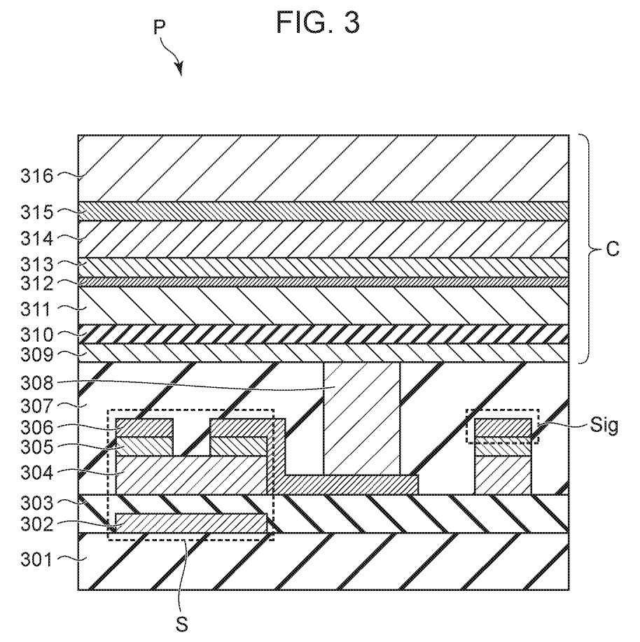

FIG. 3 schematically illustrates an example of a sectional structure of one of the pixels P. The pixel P is formed on an insulating substrate 301 such as a glass substrate. The pixel P includes a conductive layer 302, an insulating layer 303, a semiconductor layer 304, an impurity semiconductor layer 305, and a conductive layer 306 on the insulating substrate 301. The conductive layer 302 forms a gate of a transistor (such as a TFT) that is included in the switch element S. The insulating layer 303 covers the conductive layer 302. The semiconductor layer 304 is disposed along a portion of the conductive layer 302 that forms the gate with the insulating layer 303 interposed therebetween. The impurity semiconductor layer 305 is disposed on the semiconductor layer 304 so as to form two main terminals (a source and a drain) of the transistor that is included in the switch element S. The conductive layer 306 forms a wiring pattern that is connected to the two main terminals (the source and the drain) of the transistor that is included in the switch element S. A portion of the conductive layer 306 forms the signal line Sig, and another portion forms a wiring pattern for connecting the conversion element C and the switch element S to each other.

The pixel P further includes an interlayer insulating film 307 that covers the insulating layer 303 and the conductive layer 306. In the interlayer insulating film 307, a contact plug 308 for connection to the conductive layer 306 (the switch element S) is provided. The pixel P further includes a conductive layer 309, an insulating layer 310, a semiconductor layer 311, an impurity semiconductor layer 312, a conductive layer 313, a protection layer 314, an adhesive layer 315, and a scintillator 316 in this order on the interlayer insulating film 307. These layers form an indirect conversion element C. The conductive layer 309 and the conductive layer 313 form a lower electrode and an upper electrode of a photoelectric conversion element that is included in the conversion element C. For example, the conductive layer 313 is composed of a transparent material. The conductive layer 309, the insulating layer 310, the semiconductor layer 311, the impurity semiconductor layer 312, and the conductive layer 313 are included in a MIS sensor that serves as the photoelectric conversion element. For example, the impurity semiconductor layer 312 is formed by using an n-type impurity semiconductor layer. For example, the scintillator 316 is composed of a gadolinium material or a cesium iodide (CsI) material and converts radiation into light.

The conversion element C may be a direct conversion element that directly converts the entering radiation into an electric charge instead of the example described above. Examples of the direct conversion element C include a conversion element composed of amorphous selenium, gallium arsenide, gallium phosphorus, lead iodide, mercuric iodide, CdTe, and/or CdZnTe. The conversion element C is not limited to a MIS conversion element, and examples thereof may include a p-n or PIN photodiode.

In an example illustrated in FIG. 3, the multiple signal lines Sig overlap portions of the conversion elements C in an orthographic projection (a plan view) of a surface of the insulating substrate 301 on which the pixel arrays 200 are formed. This structure is advantageous in that the area of the conversion element C of each pixel P can be increased.

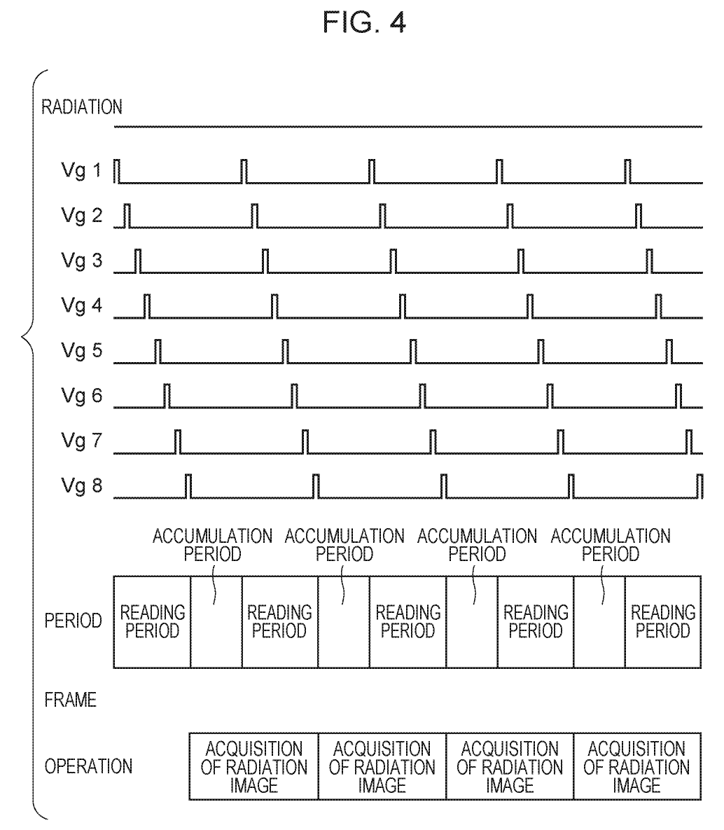

An example of the operation of the radiation imaging system 100 will be described with reference to FIG. 4. An upper portion in FIG. 4 illustrates a timing chart, and a lower portion in FIG. 4 illustrates the flow of signal processing. For example, an operation illustrated in FIG. 4 starts in response to an instruction from the user of the radiation imaging system 100. The operation of the radiation imaging system 100 is controlled by the computer 120. The operation of the radiation imaging apparatus 110 is performed by the control circuit 112 under control of the computer 120. Specifically, the control circuit 112 performs the operation in FIG. 4 by controlling the drive circuits 210 and the reading circuits 220. In some cases, the control circuit 112 performing a specific operation by controlling the drive circuits 210 or the reading circuits 220 is simply referred to below as the control circuit 112 performing a specific operation.

"Vg 1" to "Vg 8" in the timing chart in FIG. 4 represent the level of a driving signal that is supplied from each drive circuit 210 to the drive lines Vg1 to Vg8. In an example in FIG. 4, the pixel arrays 200 include eight pixel rows, but the number of the pixel rows is not limited thereto.

In the timing chart in FIG. 4, "PERIOD" represents a period in which a specific operation is performed. As for imaging with the radiation imaging apparatus 110, an accumulation operation is performed in an accumulation period, and a reading operation is performed in a reading period. The control circuit 112 selects none of the multiple pixels P that are included in the pixel arrays 200 in the accumulation period. Specifically, the drive circuits 210 maintain a state in which the off signal is supplied to the drive lines Vg1 to Vg8 (a state in which no driving signal is supplied). Consequently, the electric charge that is generated by each conversion element C is accumulated by the conversion element C.

The control circuit 112 selects each of the multiple pixels P that are included in the pixel arrays 200 and reads a signal from the selected pixel P in the reading period. Specifically, the drive circuits 210 supply the on signal to the drive lines Vg1 to Vg8 one by one. One of the drive circuits 210 first supplies the on signal to the drive line Vg1. Consequently, the switch element S (1, j) (j = 1, …, n) is turned on, the conversion element C (1, j) and the signal line Sigj are brought into the conducting state, and accordingly, the electric charge that is accumulated by the conversion element C (1, j) is read on the signal line Sigj. Subsequently, the drive circuit 210 supplies the on signal to the drive line Vg2. Consequently, the switch element S (2, j) is turned on, the conversion element C (2, j) and the signal line Sigj are brought into the conducting state, and accordingly, the electric charge that is accumulated by the conversion element C (2, j) is read on the signal line Sigj. The drive circuit 210 repeats these operations until the drive line Vg8, and consequently, an electric charge based on the electric charge that is accumulated by the conversion element C is read by one of the reading circuits 220 through the signal line Sigj. That is, the drive unit supplies the driving signal sequentially to the multiple drive lines Vg1 to Vg8, and the reading unit reads a signal depending on the electric charge from each pixel and generates the image data signal. In the following description, performing the reading operation on the multiple pixels P means performing the reading operation on each of the multiple pixels P.

The control circuit 112 captures moving images (that is, captures multiple radiation images). The control circuit 112 performs the accumulation operation and the reading operation in turns. As illustrated in FIG. 4, the accumulation operation is performed, and subsequently, a signal based on the electric charge that is accumulated by the multiple pixels P is read.

The image generating circuit 113 generates the radiation image data signal, based on the image data signal that is read from the multiple pixels P that are included in the pixel arrays 200. A radiation image X is represented as a matrix having m rows and n columns. A signal that is read from the pixel P (i, j) corresponds to a (i, j) component of the matrix.

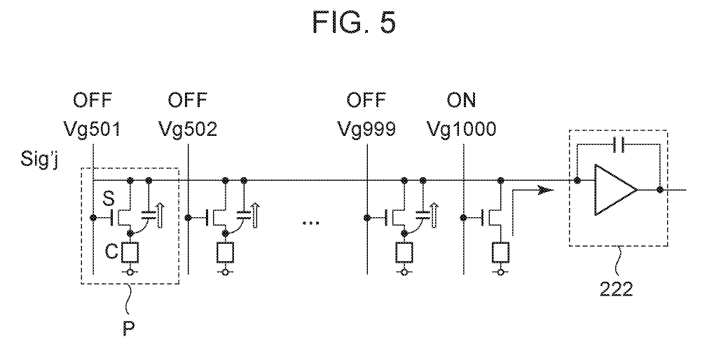

A crosstalk that occurs at the radiation detection panel 111 will be described with reference to FIG. 5.

In the case described according to a first embodiment, the radiation that is emitted from the radiation generating device 140 is temporally continuous. In the case where the radiation that is emitted from the radiation generating device 140 is temporally continuous, all of the pixels are irradiated with the radiation during reading, and the electric charge of each conversion element C changes. A signal based on an electric charge is transmitted through each signal line due to coupling capacitance. FIG. 5 illustrates an example of the pixels in the j-th column in the case where the switch in 1000-th row is on. In FIG. 5, signals based on the electric charges of the conversion elements C in the 501-th row to 999-th row to which the signal line Sigj is connected are superimposed as the crosstalk on a signal in 1000-th row. Similarly, as for the other rows, a signal in a non-selected row (a row to which no driving signal (no on signal) is supplied) to which the signal line Sigj is connected is superimposed on a signal corresponding to the electric charge in a selected row (a row to which the driving signal (the on signal) is supplied).

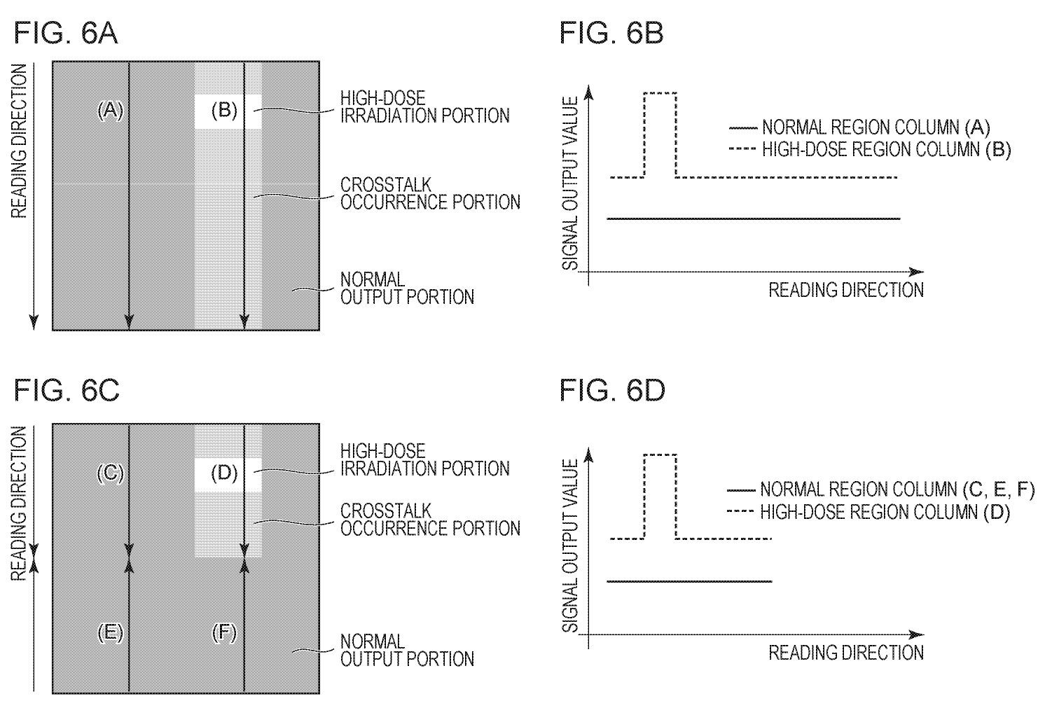

The form of a crosstalk that appears in an image will be described with reference to FIG. 6A to FIG. 6D. FIG. 6A is a conceptual diagram in the case where the signal of the radiation detection panel 111 is read in a single direction during imaging when a high dose of radiation is emitted to a freely selected location with no object placed. FIG. 6B illustrates an example of signal output values in (A) and (B) columns in a reading direction in the image in FIG. 6A. FIG. 6C is a conceptual diagram in the case where the signal of the radiation detection panel 111 is read in up-down directions (in the case of reading with the structure in FIG. 2). FIG. 6D illustrates an example of signal output values in (C), (D), (E) and (F) columns in the reading direction in the image in FIG. 6C. That is, a drive line having a small number is plotted on the left-hand side of the horizontal axis in FIG. 6B and FIG. 6D, and a drive line having a large number is plotted on the right-hand side. When a specific location on the radiation detection panel 111 is irradiated with a high dose of radiation, an outputted signal in a column that is irradiated with the high dose of radiation has a larger value than a signal in a column that is not irradiated with the high dose of radiation due to the crosstalk. In the case of reading in the up-down directions as described above, a step is generated at a central portion unlike reading in the single direction, and the crosstalk more remarkably appears in the image.

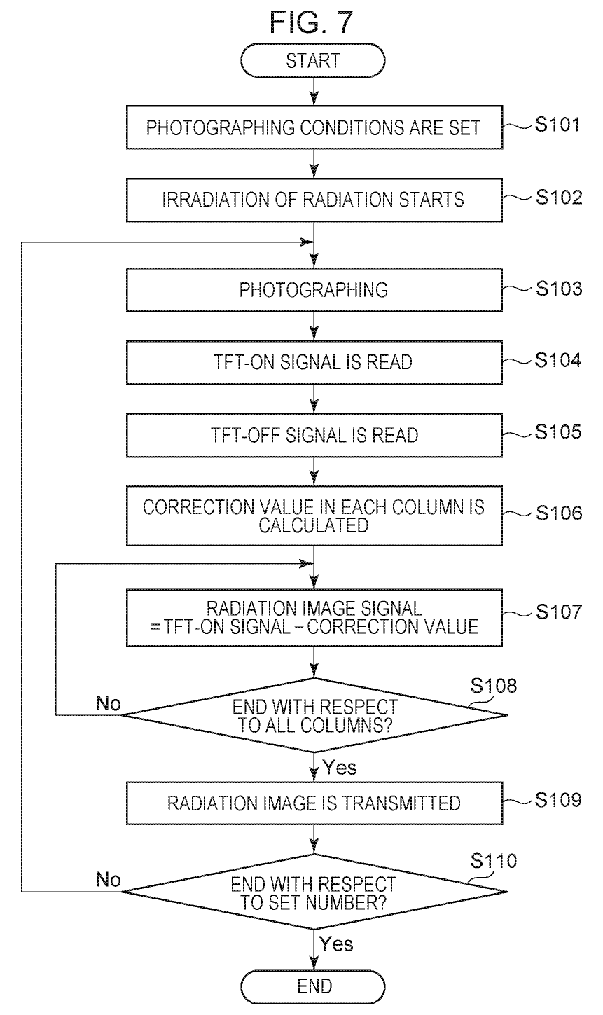

The flow of image output after the crosstalk is corrected will be described with reference to FIG. 7. At step S101, photographing conditions such as an accumulation time, a gain, and the number of photographs are set. At step S102, the temporally continuous irradiation of the radiation starts. At step S103, the control circuit 112 receives a signal for the start of photographing from the computer 120 and starts photographing in the set conditions at step S101. At step S104, the drive lines Vg1 to Vgn are sequentially driven after a predetermined accumulation time, and a radiation signal in each row is read. In the case of reading in the up-down directions (in the case of the structure in FIG. 2), the drive lines Vg'1 to Vg'n are sequentially driven as in the drive lines Vg1 to Vgn. Subsequently, at step S105, signals on the signal lines Sig are read for a predetermined time with no drive lines Vg driven. Specifically, in the case of the structure in FIG. 2, Vg1 to Vg500 are driven, and subsequently, signals on the signal lines Sig are read for a predetermined time with no driving signal supplied to the drive lines Vg1 to Vg500. Similarly, Vg1000 to Vg501 are driven, and subsequently, signals on the signal lines Sig are read for a predetermined time with no driving signal supplied to the drive lines Vg1000 to Vg501. At this time, the longer the reading time, the more the level of noise is averaged, but the maximum frame rate cannot be increased accordingly. Accordingly, appropriate settings depending on a time required for reading the pixel rows and the accumulation time that is set at step S101 are required. For example, according to the embodiment, no driving signal is supplied to the drive lines at 30 times (a time required for scanning 30 drive lines), and signals on the signal lines Sig are read. However, this is not a limitation, a reading operation is performed at multiple times, but the reading operation may be performed only once depending on the photographing conditions. At step S106, a correction value in each pixel column is calculated from an average value acquired by averaging output signals that are read at step S105 when no drive lines Vg are driven (a process of averaging the sum of 30 outputs). At step S107 and step S108, the radiation image signal is calculated from a difference between the radiation signal that is read at step S104 in each pixel row and the correction value that is calculated at step S106 in each pixel column. Specifically, the signal output value in (B) in FIG. 6B is adjusted to the same level as the signal output value in (A), and the signal output value in (D) in FIG. 6D is adjusted to the same level as the signal output values in (C, E, F).

After the radiation image signal in each row is calculated, that is, processing ends with respect to all of the pixel rows of the radiation detection panel 111, the radiation image is transmitted to the computer 120 at step S109. At step S110, whether the number of photographs reaches a photographing number that is set at step S101 is determined. In the case where the number of photographs does not reach the photographing number, step S103 to step S109 are repeated.

According to the embodiment, the operation of reading the radiation image signal is performed during the continuous irradiation of the radiation, and accordingly, the image signal contains a crosstalk component. However, signals are read from the signal lines with no driving signal supplied to the drive lines, and the image signal is corrected by using the signals. This enables the crosstalk component to be removed from the image signal and enables a correct radiation image to be acquired. According to the embodiment, a crosstalk correction signal is acquired in a period after an image signal for a single screen is read and before an image signal for a subsequent screen is read, in other words, a period (a frame switch period) between screens, as described above. For this reason, a crosstalk correction value can be acquired, and a crosstalk correction can be made while the frame rate is inhibited from decreasing.

As for the order of acquisition of signals for generating a single image in the description according to the embodiment, output signals when the drive lines Vg are driven are acquired, and output signals when no drive lines Vg are driven are subsequently acquired. However, the output signals when no drive lines Vg are driven may be first acquired, and the output signals when the drive lines Vg are driven may be subsequently acquired provided that these operations are a series of operations. In the above description, the direction of drive of the drive lines Vg is a direction from the outside to the inside of the radiation detection panel 111. However, the direction of drive may be a direction from the inside to the outside. In the case where upper and lower two reading circuits (the first reading circuit (the first reading unit) and the second reading circuit (the second reading unit) are included as in the structure illustrated in FIG. 2, the two reading circuits may be simultaneously operated.

### Second Embodiment

In a correction method described according to the first embodiment, signals with the radiation emitted without deriving are used. With this structure, there is a possibility that the reference value of a so-called dark current when reference radiation is not emitted is not known, and excessive correction is made. It is thought that the reference value is measured before the radiation is emitted, but the reference value varies due to the influence of temperature drift in continuous long-term use, and the correction cannot be accurately made. A technique described below for solving this issue is that a pixel that is not sensitive to the radiation, that is, a co-called optical block (OB) pixel is disposed on the radiation detection panel 111, and the reference value is corrected based on the output value of the OB pixel. The optical block (OB) pixel is configured by covering a conversion element by using a shield member that shields radiation or light.

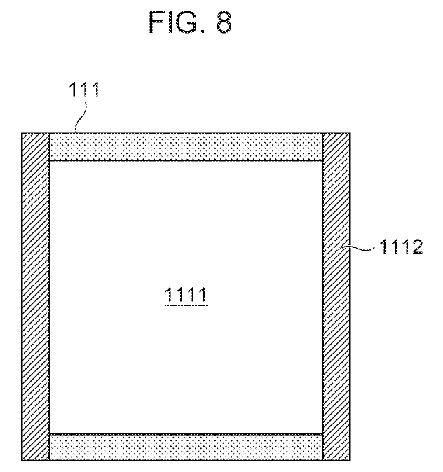

The radiation detection panel 111 that includes OB pixels will be described with reference to FIG. 8. An effective pixel region 1111 at the center of the radiation detection panel 111 has the structure in FIG. 2 described above. OB pixel regions 1112 are provided in several columns, for example, three columns at left-hand and right-hand end portions of the radiation detection panel 111. For example, the OB pixel regions have a structure in which typical pixels are covered by a metal film, and light acquired by the conversion of the scintillator 316 is not received. A portion of the panel may be covered by a structure so as not to be irradiated with the radiation. An equivalent capacitance alternative to a photodiode of a pixel may not accumulate the electric charge due to the radiation. The angle of view of an image to be outputted corresponds to the effective pixel region, and regions other than the effective pixel region such as the OB pixel regions are not driven or output nothing even when being driven. Accordingly, sensitivity to the radiation may be or may not be provided. In the case where the output image of the detection panel is rectangular, the effective pixel region is used.

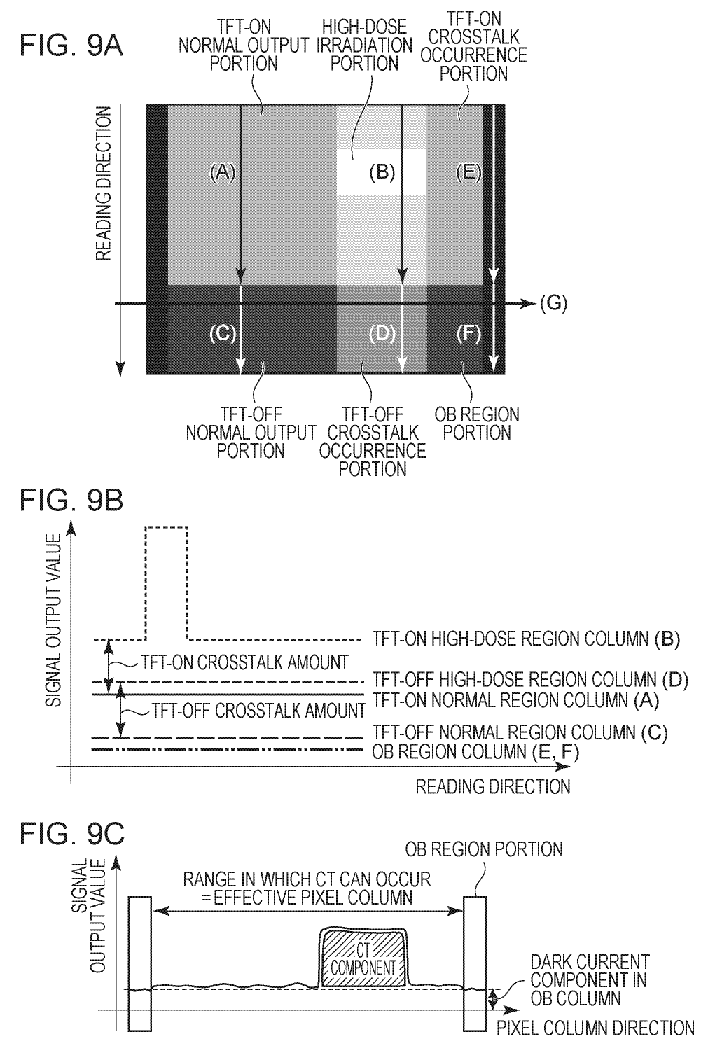

The crosstalk correction of the radiation detection panel 111 that includes the OB pixels will be described with reference to FIG. 9A to FIG. 9C. FIG. 9A illustrates photographing when a freely selected location is irradiated with a high dose of radiation with no object placed. As for the photographing, an output image is schematically illustrated where signals of pixels in the effective pixel region are read, and subsequently, signals are continuously read from the signal lines in a state in which drive lines Vg in rows within the half of the effective pixel region are not driven. FIG. 9B illustrates an example of signal output values of a normal output portion, a high-dose irradiation portion, a crosstalk occurrence portion, and an OB region portion in the output image in FIG. 9A. The normal output portion means a portion that is irradiated with a normal dose of radiation. The crosstalk affects all of the columns of the signal lines Sig, and accordingly, the influence of the crosstalk is exerted also when no drive lines Vg are driven as described above. Accordingly, the signal output value in a column of the high-dose irradiation portion is larger than the signal output value in a column of the normal output portion. A difference between the signal output value of a TFT-ON crosstalk occurrence portion and the signal output value of a TFT-ON normal output portion is referred to an a TFT-ON crosstalk amount. A difference between the signal output value of a TFT-OFF crosstalk occurrence portion and the signal output value of a TFT-OFF normal output portion is referred to as a TFT-OFF crosstalk amount. As illustrated in FIG. 9B, the TFT-ON crosstalk amount is substantially equal to the TFT-OFF crosstalk amount. In one embodiment, the OB region portion is not affected whenever being irradiated with the radiation, and the signal output thereof depends on only the amount of dark current due to a noise component of an electric circuit and is constant. FIG. 9C illustrates an example of the signal output value of a location of (G) in FIG. 9A. The OB region portion always has a constant output due to a dark current component, and accordingly, the crosstalk amount due to the irradiation of the radiation in the column of each signal line Sig is determined by subtracting the average value thereof from the output value of the effective pixel region. The value that is determined in this way corresponds to only a purely increased component due to the crosstalk.

Consequently, the dark current can be corrected in addition to the crosstalk correction, and accordingly, a more accurate radiation image than that according to the first embodiment can be acquired.

According to the embodiments described above, the crosstalk can be reduced with precision while the frame rate is inhibited from decreasing and the power consumption is inhibited from increasing.

### Other Embodiments

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-205453, filed November 26, 2024, which is hereby incorporated by reference herein in its entirety.

What is claimed is:

1. An apparatus comprising:
multiple pixels including respective conversion elements that convert radiation or light into an electric charge and respective switch elements that output the electric charge generated by the conversion elements or a signal based on the electric charge, the multiple pixels being arranged in a matrix;
a drive unit that outputs a driving signal for driving the switch elements;
multiple drive lines that supply the driving signal outputted by the drive unit to the switch elements;
a reading unit that processes the signal outputted from the pixels;
multiple signal lines that are provided in association with columns of the pixels and that supply the signal generated by the pixels to the reading unit;
a control unit that controls an operation of the drive unit and an operation of the reading unit; and
a generating unit that receives a signal outputted from the reading unit and that generates a data signal,
wherein while the radiation is emitted, the control unit causes a first operation to be performed such that the drive unit supplies the driving signal sequentially to the multiple drive lines and the reading unit generates a first signal, and causes a second operation to be performed right after the first operation such that the drive unit supplies no driving signal to the multiple drive lines and the reading unit generates a second signal, and
wherein the generating unit corrects the first signal by using the second signal and generates the data signal.

2. The apparatus according to claim 1,
wherein the control unit causes the drive unit and the reading unit to perform the second operation multiple times such that multiple second signals are generated and the first signal is corrected by using a signal obtained by averaging the multiple second signals.

3. The apparatus according to claim 1,
wherein the reading unit includes a first reading unit and a second reading unit, the first reading unit processes a signal outputted from at least one pixel among the multiple pixels, and the second reading unit processes a signal outputted from another pixel other than the at least one pixel among the multiple pixels.

4. The apparatus according to claim 3,
wherein the control unit causes the first reading unit and the second reading unit to simultaneously operate.

5. The apparatus according to claim 1,
wherein the multiple pixels include a first pixel and a second pixel, the conversion element that is included in the second pixel is covered by a shield member that shields the radiation or the light.

6. The apparatus according to claim 5,
wherein the generating unit is configured to:
correct a first signal generated in the first operation in a manner in which the reading unit processes a signal outputted from the first pixel, by using a second signal generated in the second operation in a manner in which the reading unit processes a signal outputted from the first pixel, and a first signal generated in the first operation in a manner in which the reading unit processes a signal outputted from the second pixel or a second signal generated in the second operation in a manner in which the reading unit processes a signal outputted from the second pixel; and
generate the data signal.

7. A system comprising:
the apparatus according to claim 1; and
a control device that acquires the data signal from the apparatus and that processes the acquired data signal.

8. The system according to claim 7,
wherein the control unit in the apparatus causes the drive unit and the reading unit to perform the second operation multiple times such that multiple second signals are generated and the first signal is corrected by using a signal obtained by averaging the multiple second signals.

9. The system according to claim 7,
wherein the reading unit in the apparatus includes a first reading unit and a second reading unit, the first reading unit processes a signal outputted from at least one pixel among the multiple pixels, and the second reading unit processes a signal outputted from another pixel other than the at least one pixel among the multiple pixels.

10. The system according to claim 9,
wherein the control unit in the apparatus causes the first reading unit and the second reading unit to simultaneously operate.

11. The system according to claim 7,
wherein the multiple pixels in the apparatus include a first pixel and a second pixel, the conversion element that is included in the second pixel is covered by a shield member that shields the radiation or the light.

12. The system according to claim 11,
wherein the generating unit in the apparatus is configured to:
correct a first signal generated in the first operation in a manner in which the reading unit processes a signal outputted from the first pixel, by using a second signal generated in the second operation in a manner in which the reading unit processes a signal outputted from the first pixel, and a first signal generated in the first operation in a manner in which the reading unit processes a signal outputted from the second pixel or a second signal generated in the second operation in a manner in which the reading unit processes a signal outputted from the second pixel; and
generate the data signal.
